(19) United States
(12) Patent Application Publication
(10) Pub. No.: US 2006/0120935 A1
(43) Pub. Date: Jun. 8, 2006

(54) Efficient removal of mercury from flue gases

(76) Inventors: Hal Stuhler, Allenwood, NJ (US); Steven C. Amendola, Ocean, NJ (US)

Correspondence Address: BAKER & BOTTS, 30 ROCKEFELLER PLAZA, NEW YORK, NY, 10112, US

(21) Appl. No.: 11/263,697

(22) Filed: Nov. 1, 2005

Related U.S. Application Data
(60) Provisional application No. 60/623,989, filed on Nov. 1, 2004.

(51) Int. Cl. B01D 53/64; B01D 53/34

(52) U.S. Cl. 423/210; 422/168

(57) ABSTRACT

The invention provides for the removal of mercury from flue and other mercury-contaminated gases. Compositions, systems and methods for the removal of elemental mercury and mercury compounds from flue gases are provided.

### CROSS-REFERENCE TO RELATED APPLICATION

This application claims the benefit of U.S. Provisional Application No. 60/______, filed on Nov. 1, 2004, entitled “Efficient Removal of Mercury From Flue Gases” which is hereby incorporated by reference in its entirety.

### TECHNICAL FIELD OF THE INVENTION

The invention relates generally to the removal of mercury from flue gases. In particular, the invention relates to materials, systems and methods for the removal of elemental mercury and mercury compounds from flue gases.

### BACKGROUND OF THE INVENTION

The burning of fossil fuels, particularly coal and other solid fuels, releases mercury into the atmosphere, which in turn causes mercury pollution of both land and water. In recent years, the U.S. Environmental Protection Agency and state environmental agencies have identified the combustion of fossil fuels by electric utilities as a significant source of mercury emissions and are preparing regulations to limit the quantities of mercury that may be emitted by electric utilities.

Two main approaches to mercury removal are now under development: (1) modification of the scrubbers (or scrubber liquids) that are currently used to remove non-particulate air pollutants like sulfur dioxide; and (2) introduction of a separate system for mercury absorption.

While the approach of incorporating mercury-absorbing additives into the scrubber liquid offers the prospect of a simple and cheap solution, that approach has several critical drawbacks. First, modifying the scrubber liquid has yet to demonstrate removal a sufficiently high percentage of mercury from flue gases to satisfy environmental requirements. Further, even if it were possible to remove a sufficient fraction of the mercury, existing desulphurization scrubbers produce large quantities of waste calcium sulfate and/or sulfite slurry that, once contaminated with mercury, could no longer be treated as non-hazardous waste and would require a different, more expensive, disposal treatment.

The problems associated with the disposal of large quantities of mercury-contaminated waste produced by scrubbers would naturally be eliminated if the mercury absorber were separated from the scrubber. Several candidate materials have been proposed for use in this approach. These materials include well-known, simple absorbers, such as zeolites and charcoals, or metals that will form an amalgam with mercury, such as silver or gold. Needless to say, the initial capital investment associated with a system based solely on silver or gold-would be considerable, and a means for reliably recovering the used materials from the system would be essential for it to be economically feasible. Clearly, cheaper materials would be preferable.

In terms of the simple absorbers, it has been found that carbon injected into the flue gas stream will act to absorb mercury in its elemental state. However, depending on the source of the mercury and the burn conditions, anywhere from 10 to 90% of the mercury in the flue gases may be oxidized, and therefore not amenable to absorption by simple absorbers such as carbon, imposing severe limits on the application of this approach. Further, even though carbon injection has the advantage of being relatively cheap to implement, it has the distinct disadvantage that mercury-contaminated carbon will become mixed with the fly ash byproducts of solid fuels. Once contaminated with mercury, fly ash that would otherwise be sold to the cement industry would have to be treated as hazardous waste, in the absence of an economical method for distilling off the mercury.

Similar to carbon injection, the success of gold and silver in forming mercury amalgams is offset by the fact that these materials have not been shown capable of absorbing mercury compounds, allowing, for example, oxidized mercury to enter the atmosphere. As noted above, the fraction of oxidized mercury in flue gases can be between 10 and 90%, meaning that as much as 90% of the mercury could escape from a device using a silver or gold amalgam as a mercury absorber.

### SUMMARY OF THE INVENTION

In view of the above-mentioned problems and shortcomings associated with the removal of mercury from flue gases, an embodiment of the invention provides a material, system and method for the absorption of both elemental mercury and mercury compounds from flue gases. According to the invention, the flue gases are passed over a material that reduces the mercury compounds to elemental mercury and other materials which amalgamate the elemental mercury or reduced mercury compounds. The amalgam may be removed as a solid or liquid and recycled to recover the mercury and the amalgamating material.

### DETAILED DESCRIPTION OF THE INVENTION

The present invention provides for the reduction of mercury compounds, including mercury oxide present in flue gases and the absorption of elemental mercury, including that produced by the reduction process, thereby reducing mercury emissions into the atmosphere. For the purposes of the application, oxidized mercury compounds will be represented by HgO. However, it is understood that this represents all oxidized mercury compounds including, but not limited to, mercury sulfides, mercury chlorides, mercury halides, and organo-mercury compounds, all of which can be reduced to mercury.

In one embodiment, metals or alloys are used to reduce mercury compounds and amalgamate with mercury present in flue gases. The metals zinc, copper, cadmium, tin, lead, indium, gallium, thallium, bismuth, all the alkali (Group I) metals (lithium, sodium, etc.), all the alkaline (Group II) metals (beryllium, magnesium, etc.), aluminum, all the rare earth metals (the lanthanides, with atomic number 57-71, the actinides, with atomic number 90 to 103) and any alloys formed from two or more of the preceding elements may be used. In another embodiment, gold and silver, for example, though not useful for their reducing properties, may be added to enhance the amalgamation process.

The above metals or alloys may be used in any one of a variety of suitable physical forms. Examples of such forms include wires, rods, sheets, wool, mossy, powder, dust, nanoparticulate, meshes, screens and the like. The above-described metals or alloys may also be dispersed on a high surface material, such as activated carbons, silica, zeolites, or metal oxide(s) in powder, pressed or frit form.

The reduction of oxidized mercury by elemental zinc and the subsequent amalgamation of the freed mercury may be described by the following equation:
HgO+2Zn→Zn(Hg)+ZnO (1)

According to equation (1), while one atom of zinc exothermically reduces the mercury oxide to metallic mercury, a second atom of zinc is free to form an amalgam with the mercury atom.

In contrast, as set forth by the following equation, there is no reaction between oxidized mercury and gold:
HgO+Au→No Reaction (2)

Any metal or alloy, M_{R+A}, that exhibits a suitably high reduction power, and can form an amalgam with mercury, can react in a similar fashion to zinc, as described by the following equation:
HgO+2M_{R+A}→M_{R+A}(Hg)+M_{R+A}O (3)

Indeed, any element, compound or alloy that can perform the two functions described in equation (3), is a suitable candidate for the reduction of mercury compounds, including mercury oxide, and the amalgamation of elemental mercury in flue gases.

The above equations indicate that gold (or for that matter, silver) will not reduce oxidized mercury other mercury compounds, and explain why gold and silver alone, or in combination, are generally unsuited for removing mercury from flue gases, since as little as 10% of the mercury present in flue gases is in elemental form.

In another embodiment, a combination of materials may be used having one or more elements reactive enough to reduce the oxidized mercury, but lacking the power to amalgamate the mercury liberated as a result of the reaction, and one or more elements capable of amalgamating mercury, but not sufficiently reactive to reduce mercury compounds Iron, for example, is sufficiently reactive to reduce mercury oxide, but does not form an amalgam with elemental mercury. A preferred embodiment of the present invention is a material combining iron and zinc. (At current prices, iron and zinc are between 4,000 and 10,000 times cheaper than gold.) In the case of a binary combination of iron and zinc, the relevant reactions may be described as follows:
HgO+Fe→FeO+Hg (4)
Hg+Zn→Hg(Zn) (5)

Indeed, any material, M_{R>Hg}, as set forth below in equation 6, with sufficient power to reduce any form of oxidized mercury, may form at least part of the present invention:
M_{R>Hg}+HgO→Hg+(M_{R>Hg})O (6)

Further, mercury that is chemically combined with other materials or in other oxidation states, +1, +2, and 0, can be treated using the present invention. Such materials include sulfides, oxides and halides, any Group 15, 16 or 17 compounds, organic compounds or ligands, such as methyl mercury. In the following equation, the material in chemical combination with mercury is denoted X and any suitable reaction agent as M_{R>Hg}.
yM_{R>Hg}+HgₐX_{b}→(M_{R>Hg})_{y}X_{b}+aHg (7)

Thus, M_{R>Hg} in the above equation includes all materials having a reducing power greater than that of mercury, which naturally includes the list of metals, M_{R+A} that can reduce a mercury compound and form an amalgam with mercury, and all of the transition metals, with the exception of gold, silver, iron, nickel and platinum.

The reduction half-equations for mercury are as follows:
Hg²⁺+2e⁻→Hg E_{1/2}=+0.85 eV (8)
2Hg⁺+2e⁻→2Hg E_{1/2}=+0.79 eV (9)

The relatively low values of 0.85 and 0.79 electron volts are indicative of the ease with which mercury can be reduced. Indeed, only three elements, gold, platinum and silver, are unable to affect the reduction of mercury compounds.

Further, in light of these low energy values, it is a relatively simple matter to identify compounds, in addition to the above-listed metals and alloys, that can affect the reaction described by equation 7. Examples of such compounds include, but are not limited to, hydrazine, azide and borohydride salts, and elements having salts where the reduced state(s) can reduce mercury, such as V²⁺, Cr²⁺, Cu⁺, Ti²⁺, Fe²⁺, etc., sulphides and reducing organic compounds, such as sugar, alcohol, formic acid, hydroquinone, etc. Examples of reactions with such compounds include the following:
N₂H₄+HgO→Hg+N₂+2H₂O (10)
2NaN₃+HgO→2Hg+3N₂+Na₂O (11)

The nitrogen and water produced by the reaction shown in equation 10 are harmless byproducts, while the mercury may be amalgamated with any suitable metal. The hydrazine reactant used in equation 10 may be introduced in the form of a solid, such as hydrazine sulfate, or a liquid, such as hydrazine in a water solution, or may be absorbed onto any suitable material, such as activated carbon or zeolites, etc.

According to a further embodiment of the present invention, any material that can amalgamate with and reduce mercury (such as zinc or brass), or a combination of one or materials (for example, brass, bronze, aluminum, zinc, iron/copper, iron/gold, aluminum/silver, etc.), or any combination of these materials deposited on a suitable substrate, such as carbon or ceramic beads, monoliths (such as are used in catalytic converters), may be placed in the flow of gases coming from a flue or any mercury-contaminated gas stream.

The material may be placed before or after a bag house, if one is used, or in any other suitable location in the gas stream. In a another embodiment, the mercury absorbing material may be the form of an easily removable filter screen(s) to reduce maintenance costs. In yet another embodiment, mercury detectors may be placed upstream and downstream of the mercury absorber to determine when the mercury absorber needs to be changed.

In a further embodiment, the reducing compound may be dissolved in water, as described above, and introduced as a spray together with a compound or material that can amalgamate mercury. Examples of such water soluble reducing compounds include, but are not limited to, hydrazine, azide and borohydride salts, elements having salts where the reduced state(s) can reduce mercury, such as V²⁺, Cr²⁺, Cu⁺, Ti²⁺, Fe²⁺, etc., sulphides and reducing organic compounds, such as sugar, alcohol, formic acid, hydroquinone, etc. The mercury containing liquid may be extracted and the mercury then removed from the liquid using any of a number of standard techniques, including but not limited to, decantation, centrifaction, filtration, precipitation and ion exchange techniques.

In a preferred embodiment, the mercury removing material is located at a portion of the gas stream that is sufficiently cool to allow the amalgam to form, but not so hot as to cause the amalgamated mercury to evaporate from the material. In a preferred embodiment, the device containing the mercury removing material may be placed in a part of the flue gas where the temperature is below 300° C. and preferably below 150° C. (the boiling point of mercury at atmospheric pressure is 356° C. and it has a high vapor pressure).

In another embodiment, the mercury-absorbing material, once used, may be heated to boil off and then recover the amalgamated mercury. In a further embodiment, the material may be placed in a reduced pressure, thereby reduce the temperature required for mercury removal. Following mercury removal, the absorber may be reused to absorb further mercury or simply sold for recycling. The mercury from the absorber material may be recovered, for example, using a condenser or another material set forth in this application, or by any other conventional means, and sold for beneficial reuse.

According to the present invention, with a relatively small outlay, virtually none of the mercury present in flue gases need be emitted to the atmosphere or transferred to landfills in fly ash or scrubber waste, giving rise to a significant environmental benefit.

### EXAMPLE

The following is an example of the use of the invention to remove mercury from warm air. Exactly 50 grams of mercury were placed in a glass reactor. An inlet to the reactor was fed with 1 liter/second of air at a temperature of 42° C. In this trial, the reactor itself was also heated to 42° C. The outlet for the reactor was fitted with a trap filled with 100 grams of mossy zinc. Both the inlet and outlet of the trap were monitored for mercury, giving the following mercury concentrations after successive time periods.

| Time | Inlet mercury | Outlet mercury | Mercury recovery |
|---|---|---|---|
| (hours) | concentration (ppm) | concentration (ppm) | (%) |
| 1 | 9.8 | 0.157 | 98.39 |
| 3 | 10.1 | 0.161 | 98.41 |
| 6 | 10.1 | 0.163 | 98.39 |
| 12 | 10.3 | 0.162 | 98.43 |
| 24 | 10.1 | 0.158 | 98.44 |
| 36 | 10.0 | 0.160 | 98.40 |
| 48 | 10.0 | 0.159 | 98.41 |
| 72 | 10.1 | 0.160 | 98.41 |

Following completion of this trial, the mercury charge was removed from the reactor and weighed. The weight of the mercury was 17.8945 grams, or 35.79% of the original. The mossy zinc was then taken out of the trap and weighed. The weight of the mossy zinc was 117.6077 grams, reflecting an increase 17.61%, corresponding to 98.4% of the mercury transferred from the original charge, thereby confirming the percentage recovery of 98.40% deduced from the measurements of inlet and outlet concentrations.

The mossy zinc was then vacuum distilled at 200° C. for 1 hour. The distilled mercury weighed 17.5994 grams, which represents a recovery of 99.95% of the mercury trapped by the mossy zinc. Further, the mossy zinc was determined not to have significantly changed form and could be recycled back into the system for trapping mercury.

Those of ordinary skill in the art will appreciate that the foregoing discussion of certain embodiments and preferred embodiments is illustrative only, and does not limit the spirit and scope of the present invention, which are limited only by the claims set forth below.

We claim:

1. A composition for removing mercury from a gas stream comprising materials capable of reducing mercury compounds to elemental mercury and forming an amalgam with mercury.

2. The composition of claim 1 wherein the composition includes at least one material selected from the group consisting of zinc, copper, cadmium, tin, lead, indium, gallium, thallium, bismuth,

3. The composition of claim 1 wherein the composition includes at least one material selected from the group consisting of alkali (Group I) metals (lithium, sodium, etc.).

4. The composition of claim 1 wherein the composition includes at least one material selected from the group consisting of alkaline (Group II) metals (beryllium, magnesium, etc.

5. The composition of claim 1 wherein the composition includes aluminum.

6. The composition of claim 1 wherein the composition includes all the rare earth metals (the lanthanides, with atomic number 57-71, the actinides, with atomic number 90 to 103).

7. The composition of claim 1 wherein the composition is in the form of one of a wire, rod, sheet, wool, mossy, powder, dust, nanoparticulate, mesh, and screen.

8. The composition of claim 1 wherein the composition is dispersed on a high surface material, such as activated carbons, silica, zeolites, or metal oxide(s) in powder, pressed or frit form.

9. A composition comprising a first material that reduces mercury compounds in flue gases and a second material that form an amalgam with the reduced mercury compound.

10. The composition of claim 9 wherein the first material reduces mercury compounds in flue gases at temperatures below 300° C.

11. The composition of claim 9 wherein the first material reduces mercury compounds in flue gases at temperatures below 150° C.

12. A method for removing mercury from a gas stream comprising the steps of:
passing the flue gasses over a material capable of both reducing mercury compounds to elemental mercury and forming an amalgam with mercury.

13. The method for removing mercury comprising:
reducing mercury compounds in the flue gases to elemental mercury;
amalgamating the reduced mercury compounds with a material to form a solid waste product.

14. A system for removing mercury from a gas stream comprising a mechanism for:
passing flue gasses over a material capable of reducing mercury compounds to elemental mercury and forming an amalgam with mercury.

15. The system of claim 14 wherein the material is maintained at a temperature less than 300° C.

16. The system of claim 14 wherein the material is maintained at a temperature less than 150° C.

17. A system for removing mercury from a gas stream comprising a mechanism for introducing a spray into flue gasses, wherein said spray contains a first material capable of reducing mercury compounds to elemental mercury and a second material capable of forming an amalgam with mercury.
